(19) United States
(12) Patent Application Publication
(10) Pub. No.: US 2010/0169258 A1
(43) Pub. Date: Jul. 1, 2010

(54) Scalable Parallel User Clustering in Discrete Time Window

(75) Inventors: Jun Yan, Beijing (CN); Ning Liu, Beijing (CN); Lei Ji, Beijing (CN); Zheng Chen, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/346,881

(22) Filed: Dec. 31, 2008

(51) Int. Cl. G06N 5/02; G06F 7/06; G06F 17/30

(52) U.S. Cl. 706/46; 707/E17.046; 707/E17.014

(57) ABSTRACT

Described is an internet user clustering technology, such as useful in behavioral targeting, in which users are clustered together based on MinHash computations that produce signatures corresponding to users' internet-related activities. In one aspect, users are clustered together based on commonality of signatures between each set of signatures associated with each user. The signature sets and/or clusters may be associated with timestamps, whereby clusters may be determined for a given discrete time window or set of discrete time windows. To facilitate efficient processing, existing, prior signature sets of a user may be incrementally updated (e.g., daily), and/or the MinHash computations for users are partitioned among parallel computing machines. The timestamps may be used to selectively determine a cluster within a continuous time, a time window or set of time windows.

### BACKGROUND

Given information about Internet users, such as what search terms they have entered, behavioral targeting is often performed, such as to send advertisements tailored to specific groups of users. Web personalization also is based on user-specific information, as are other technologies.

As there are too many different users to treat each one individually, users are clustered according to similarities found from such information. In user clustering, users are classically represented by their previous activities such as their search queries or clicked URLs. However, it is a challenge task to cluster millions of users, due to the high complexity of classical clustering algorithms.

Such applications are also interested in temporal clustering, such as to cluster users based on their activities in the last month. However, known temporal clustering techniques (e.g., based upon streaming data) are not adequate in that they are inefficient and inflexible, and fail to be able to cluster users in a discrete time window with any specified length. For example, streaming data techniques are unable to cluster a large number of users according to their activities on every weekend of last month, or some other discrete other time window.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which users are clustered together based on MinHash computations that produce signatures corresponding to users' internet-related activities. In one aspect, users are clustered together on the basis of having similar signature sets, e.g., based on commonality of signatures therein. The signature sets and/or clusters may be associated with timestamps or the like, whereby clusters may be determined for a given discrete time window or set of discrete time windows.

In one aspect, the signature set of one user is determined by performing the MinHash computations for a user's activities relative to a number of (e.g., twenty to thirty) permutations of combined internet-related data for a plurality of (e.g., all) users. To facilitate efficient processing, existing, prior signature sets of a user are incrementally updated as each new signature set is computed (e.g., daily). To further facilitate efficient processing, the MinHash computations for users are partitioned among parallel computing machines.

In one aspect, the timestamps may be used to selectively determine a cluster based on a continuous time, a time window or set of time windows. For example, an advertiser can determine which users were clustered together on the past ten weekends (had similar signature sets on Saturdays and Sundays only).

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for user clustering via a parallel MinHash clustering algorithm.

FIG. 2 is a flow diagram showing example steps taken to perform user clustering and merging.

FIG. 3 shows an illustrative example of a computing environment into which various aspects of the present invention may be incorporated.

### DETAILED DESCRIPTION

Various aspects of the technology described herein are generally directed towards efficiently clustering a large number of users/objects in a discrete or continuous time window. In one aspect, this is accomplished by parallel computation using a MinHash clustering algorithm with an efficient time stamp merging module. As will be understood, such clustering technology provides significant benefits in behavioral targeting, social network mining, personalization research as well as related applications.

It is understood that any of the examples described herein are only examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data processing in general.

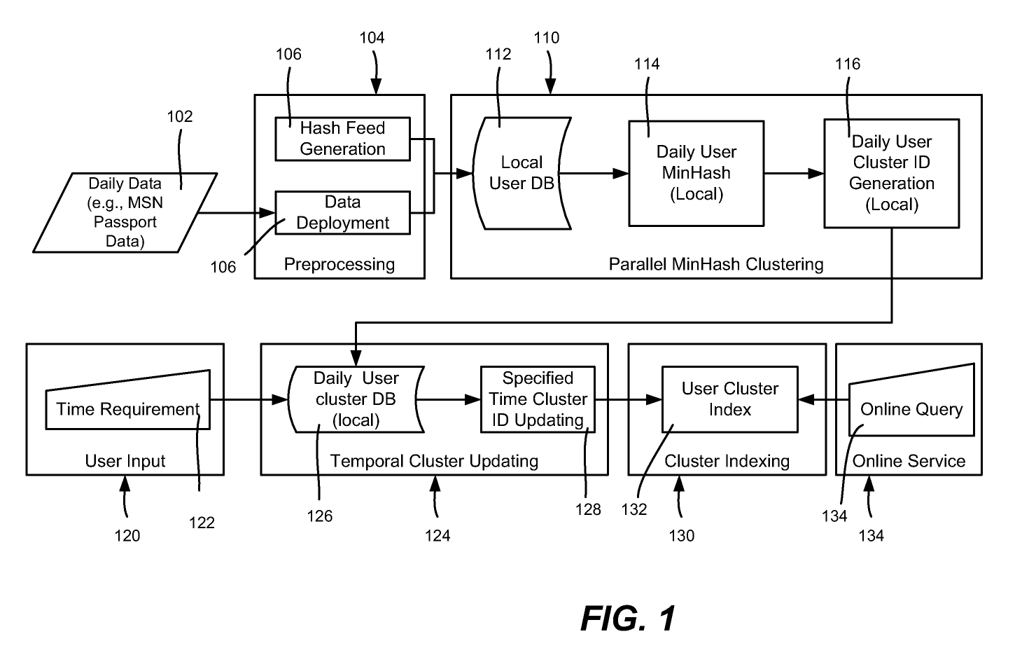

FIG. 1 shows various aspects related to user clustering, based in part on the classical MinHash clustering algorithm. In general, each user is represented by his or her previous activity data, with the data regularly imported (e.g., daily) into the parallel computation environment; (while daily computations are described hereinafter for example purposes, it is understood that more frequent computations such as every few hours or less frequent computations such as every two days may be performed). Unlike other systems, the parallel computation is performed daily on the user data. In other words, during the computation, only the daily data is generally processed, instead of independently processing the entire dataset in each local machine. The parallel environment, in conjunction with the per-day data processing, allows the algorithm to deal with a very large scale dataset and return results on any user-specified discrete time window.

As shown in FIG. 1, daily (or other timed) internet-related data 102 for users (e.g., MSN Passport data) is input into a preprocessing mechanism 104. In general, the preprocessing mechanism 104, via a data deployment component 106 and hash feed generation component 108 sorts the data of users and distributes users among different parallel machines for parallel computations.

As shown in FIG. 1, each machine 110 includes its user data as maintained in a local user database 112 or the like, where it is processed by a MinHash clustering mechanism (algorithm) 114, e.g., daily, on an incremental basis, as described below. The data is further processed by a daily user cluster ID generation component 116. In general, in MinHash processing, a set of signatures is generated for each user based on his or her activities relative to the combined activities of other users, and the signature for each user is stamped with data indicating a specific time window, e.g., the day of the users' activities.

To this end, given a set of activities, random permutations are used to calculate MinHash signatures for users. By way of example, consider that the following comprises the set of activities typed in by users:

[xbox, car, Halo3, laptop]

with the activities of user1=[xbox, Halo3],

and the activities of user2=[Halo3, laptop].

In a first round of permutations/minwise hashing the set of activities is reordered as:

[Halo3, car, laptop, xbox].

Because Halo3 is first in this ordering and each user has Halo3 as an activity, the MinHash signature of user1, mh(user1)=Halo3, and the MinHash signature of user2, mh(user2)=Halo3.

A second round permutation/minwise hash reorders the activities as:

[car, laptop, xbox, Halo3].

This time, the first to appear of those entered by user 1 is “xbox” and thus the MinHash signature of user1, mh(user1)=xbox. The first corresponding activity of what user2 entered is “laptop”, and thus mh(user2)=laptop.

The one or more MinHash signatures computed for each user comprises a signature set for that user. Given two users, the ratio of the number of shared MinHash signatures in each user's signature set between those users to the number of permutations approximates the similarity between users:

Pr(mhᵢ(u)=mhᵢ(v))=sim(u, v)

Mathematically, this may be set forth as:

Suppose H={hₖ|k=1,2, . . . c} be Min-wise independent permutation, i.e., Pr(min{hₖ(A)}=hₖ(aⱼ))=1/|A|; (c is twenty in one implementation).
Define min-wise hash function:

mhₖ(uᵢ)=arg min {hₖ(uᵢ)|uᵢ⊂A}

Then sim(uᵢ, uⱼ)=|u₁∩u₂|/|u₁∪u₂|=Pr(mhₖ(uᵢ)=mhₖ(uⱼ)) where Pr(mhₖ(uᵢ)=mhₖ(uⱼ)) is approximated by |{mh_{g}(uᵢ)=mh_{g}(uⱼ), g=1,2, . . . c}|/c.

Thus, similar users get hashed to the same bucket while dissimilar ones do not.

To summarize the upper portion of FIG. 1, to perform parallel MinHash computations, users are partitioned into different machines, with MinHash independently implemented on each machine. Note that instead of re-computing the MinHash signature for a user's activities, once a signature is available for a given user, an incremental MinHash is used, in which the MinHash signature of each user can be updated by the minimum of that user's signatures:

mh_{[t, t+k]}(u)=min {mhₛ(u), s=t, t+1, t+2, . . . t+k}.

In this way, the users activities may be regularly (e.g., daily) hashed and efficiently merged, and the incremental MinHash allows for user input of a discrete time window, e.g., every weekend in the past year, or the past 3 days, and so forth.

In the lower portion of FIG. 1, further processing uses the signatures to merge/cluster together the user-user similarity on different machines into clusters. To this end, following the local MinHash clustering on each local machine, there is provided a strategy to efficiently integrate the daily results such that a quick response may be output for any user (e.g., advertising customer) input 120 specified time window 122, whether continuous or discrete. In general, the MinHash values of each user on each day are parallel computed and recorded. Then, the updated MinHash value of any user-specified time window can be combined through a simple logical computation, described below and represented by blocks 124, 126 and 128. In one implementation, the clusters may be indexed (blocks 130 and 132) with the index 132 queried via an appropriate query 134, such as through an online service 136. For example, an online advertiser can lookup which users are clustered together with respect to a certain type of advertisement, as well as a time window as to when those users were clustered together, to send targeted advertisements to users based upon their clusters.

Turning to a detailed explanation of parallel MinHash clustering in a flexible time window, let U={uᵢ, i=1,2, . . . } represent a set of object to process and A={aⱼ, j=1,2, . . . } represent the set of attributes that represent the objects. Each object at time stamp t is represented by a set of attributes Cuᵢ(t)={aᵢ₁, aᵢ₂, . . . }, where Cuᵢ(t) is a subset of A,=1,2, . . . . In this scheme, i is treated as the unique identifier (ID) of uᵢ and j=1,2, . . . as the unique ID of aⱼ. IDs for newly appeared objects or attributes are incrementally assigned.

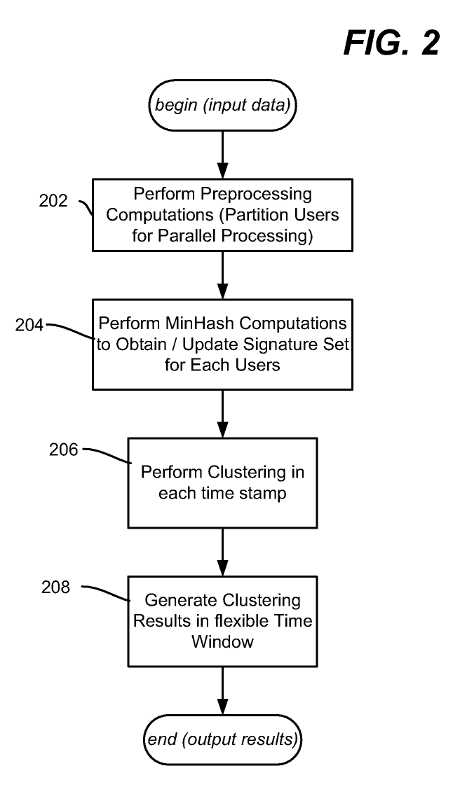

Consider that at time t there is a collection of n objects and a collection of m attributes. If a new user and new attribute appears at time t+1, n+1 and m+1 are incrementally assigned as IDs for the new user and new attribute, respectively. A parallel MinHash clustering algorithm in flexible time window is set forth below and visually represented in FIG. 2:

| | |
|---|---|
| Input: | Objects represented by attributes at time stamp t, i.e. Cuᵢ(t), |
| | i = 1, 2, ..., t = 0, 1, 2, ... |
| Output: | The cluster IDs of each object. (Note one object may |
| | belong to different clusters, thus each object has |
| | multiple cluster IDs) |
| Parameters: | p - number of hash functions |
| | q - number of rounds for MinHash approximation |
| | L - a large enough integer for constructing the hash |
| | functions |

(Note that in general, the larger the p value, the better the precision that is achieved; the larger the q value, the better the recall that is achieved. However, having a larger p and/or q will increase the computational time.)

Step 202 - Preprocessing.

Generate random feeds for constructing the hash functions.
Randomly generate integers fₖ, gₖ, k = 1, 2, ... p * q, where fₖ ≠ fₗ and
gₖ ≠ gₗ if k ≠ l.
Hash objects into different machines in the parallel environment. This can
also be done by randomly deploying objects into different machines. (The
information of the same user is stored on the same machine.)

Step 204 - MinHash

```
On each local machine,
for t=0,1,2,... (t is finite for the first time input)
    for each object on current machine
        for each attribute in Cuᵢ(t)
            suppose the current attribute ID is j
            for k = 1,2, ... p * q
                hashᵢⱼₖ (t) = (fₖ * j + gₖ)mod L
            end for
        end for
        MinHashᵢₖ(t) = minⱼ(hashᵢⱼₖ (t))
    end for
end for
```

Step 206 - Clustering in each time stamp

```
for each time stamp t,
    for each object i
        CIDSᵢₗ(t) = Ø for l = 1,2, ... q
        for k = 1,2, ... p * q
            if k mod q == l−1
                CIDSᵢₗ(t) = CIDSᵢₗ(t) ∪ MinHashᵢₖ(t)
            end if
        end for
        link all values in the same set as an ID according to the
        order of appearance in this set
        CIDSᵢₗ(t) ->CIDSᵢₗ(t)
    end for
group the objects with the same ID into a cluster
end for
```

Step 208 - Clustering results generation in flexible time window

```
For any selected time stamps, (without loss of generality), suppose the
selected time stamps are t = 0,1,2, ... s
for each object which has new attribute appear
    for k = 1,2, ... p * q
        MinHashᵢₖ=min_{t=0,1,2,...s}{MinHashᵢₖ(t)}
    end for
end for
call step 206 for clustering
```

### Exemplary Operating Environment

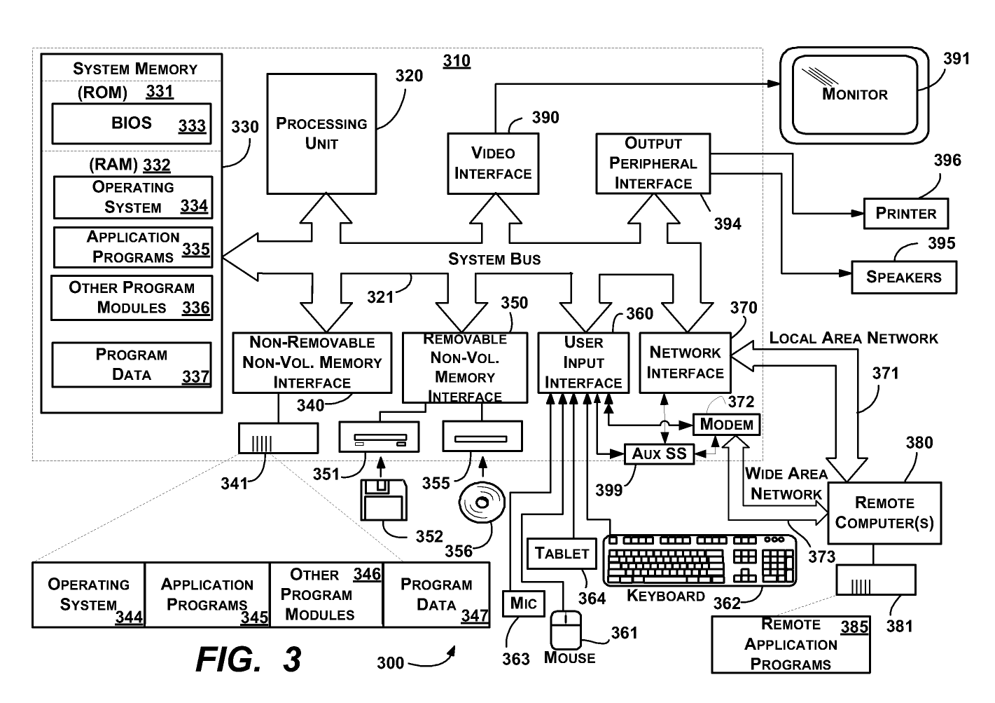

FIG. 3 illustrates an example of a suitable computing and networking environment 300 on which the examples of FIGS. 1-2 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component 374 such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, processing internet-related data corresponding to users, including determining a signature set for each user, including performing MinHash computations for that user, and clustering together users having similar signature sets.

2. The method of claim 1 wherein determining the signature set of one user comprises performing the MinHash computations on a number of permutations of combined internet-related data for a plurality of users.

3. The method of claim 1 further comprising, deploying the internet-related data for users among a plurality of machines to perform the MinHash computation for at least some of the users in parallel.

4. The method of claim 1 wherein determining the signature set comprises performing the MinHash computations to obtain an updated signature set for recent internet-related data, and incrementally updating a prior signature set computed from earlier internet-related data with the updated signature set.

5. The method of claim 4 wherein performing the MinHash computation to obtain the updated signature set occurs daily.

6. The method of claim 1 further comprising, associating a timestamp with each signature set, or with each cluster of users, or both with each signature set and with each cluster of users.

7. The method of claim 6 wherein clustering together users having similar signature sets comprises selecting signature sets based on at least one common timestamp to cluster together users within a specified discrete time window or set of time windows.

8. The method of claim 6 further comprising, selecting a cluster of users based on at least one timestamp associated with that cluster.

9. The method of claim 1 wherein clustering together users having similar signature sets includes determining how many signatures in the signature sets of a plurality of users are common to one another.

10. In a computing environment, a system comprising, a plurality of computing machines, each computing machine receiving internet-related data of different users for processing the internet-related data in parallel, each machine including a parallel MinHash computation mechanism that determines a signature set for a user that corresponds to the internet-related data, the signature set based on a computation of the user's internet-related data relative to permutations of combined internet related data of a plurality of users, and a clustering mechanism that clusters together users having similar signature sets.

11. The system of claim 10 wherein the parallel MinHash computation mechanism incrementally updates the signature set for a user based on newer internet-related data.

12. The system of claim 10 wherein the newer internet-related data corresponds to one day's internet-related activities of the user.

13. The system of claim 10 further comprising, a mechanism that clusters users together based upon their similarities within a particular time window or set of time windows.

14. The system of claim 13 further comprising a service that allows querying for user clusters in any continuous or discrete time window or set of discrete time windows.

15. One or more computer-readable media having computer-executable instructions, which when executed perform steps, comprising, processing internet-related data corresponding to a user, including performing MinHash computations for that user' internet-related data to determine a recent signature set for that user indicative of that user's activities, incrementally updating an existing signature set for that user with the recent signature set, and clustering together users having similar signature sets.

16. The one or more computer-readable media of claim 15 wherein clustering together users having similar signature sets includes determining commonality of signatures in the signature sets of a plurality of users.

17. The one or more computer-readable media of claim 15 wherein determining the signature set for the user comprises performing the MinHash computations with respect to the user's internet-related data and a number of permutations of combined internet-related data for a plurality of users.

18. The one or more computer-readable media of claim 15 having further computer-executable instructions comprising, performing the MinHash computations in parallel with other MinHash computations for at least one other user's internet-related data .

19. The one or more computer-readable media of claim 15 having further computer-executable instructions comprising, associating a timestamp with each signature set, or with each cluster of users, or both with each signature set and with each cluster of users.

20. The one or more computer-readable media of claim 15 having further computer-executable instructions comprising, determining a cluster of users based on at least one timestamp.
